(19) United States
(12) Patent Application Publication
(10) Pub. No.: US 2018/0063556 A1
(43) Pub. Date: Mar. 1, 2018

(54) SYSTEMS AND METHODS FOR PROVIDING GUEST BROADCASTING ON A LIVE STREAM VIDEO PLATFORM

(71) Applicant: YouNow, Inc., New York, NY (US)

(72) Inventors: Eran KALMANSON, Brooklyn, NY (US); Dorian Drew DARGAN, Brooklyn, NY (US); Summer Lauren BEDARD, New York, NY (US)

(21) Appl. No.: 15/260,056

(22) Filed: Sep. 8, 2016

Related U.S. Application Data
(60) Provisional application No. 62/380,732, filed on Aug. 29, 2016.

(51) Int. Cl. H04N 21/2187; H04L 29/06; H04N 21/234; H04N 21/233; H04N 21/236

(52) U.S. Cl. CPC H04N 21/2187; H04L 65/608; H04N 21/236; H04N 21/233; H04N 21/234

(57) ABSTRACT

Systems and methods for providing guest broadcasting on a live stream video platform receive a first request from a first client device to broadcast first media content to a plurality of viewing devices; receive the first media content from the first client device and broadcast the first media content to the plurality of viewing devices; receive a second request to broadcast second media content to the plurality of viewing devices concurrently with the first media content, the second media content being received from a second client device; receive the second media content from the second client device; combine the first media content with the second media content; and broadcast the first media content and the second media content concurrently as combined media content to the plurality of viewing devices.

### CROSS-REFERENCE TO RELATED APPLICATIONS

This patent application claims the benefit of priority from U.S. Provisional Patent Application No. 62/380,732, filed on Aug. 29, 2016, entitled “SYSTEMS AND METHODS FOR PROVIDING GUEST BROADCASTING ON A LIVE STREAM VIDEO PLATFORM,” which is hereby incorporated by reference in its entirety.

### FIELD OF THE INVENTION

The present invention relates generally to improved blended live stream video hosting, and more specifically, to systems and methods for providing guest broadcasting on a live stream video platform.

### BACKGROUND OF THE INVENTION

Online platforms for self-expression and communication are among the largest and most important media companies of the millennial age, dominating share of attention and engagement for young people. Millennials want to meet new friends and socialize around interesting content. Online live video broadcasting platforms such as, for example, the YouNow® platform, provide an interactive platform where anyone can participate and express themselves live. Users who stream or broadcast live and/or prerecorded video (and other content) captured on their video-camera-enabled mobile devices and/or computers are referred to herein as broadcasters. Users who view the content are referred to herein as viewers. One broadcaster can have many viewers who are able to view a broadcaster's video feed, e.g., in real-time as it is being recorded and broadcast on the platform. Some platforms, such as the YouNow® platform, further enable a broadcaster to communicate simultaneously with his or her viewers via a chat (e.g., text-based instant messaging) feed. This enables a level of interaction between broadcasters and viewers, as broadcasters are able to comment and/or reply verbally to chat messages sent to them while they are recording.

Unfortunately, current platforms only allow for a one-sided video conversation in which a broadcaster responds to comments/questions received as text. What is needed, therefore, is a platform which can enable a broadcaster to invite a “guest” viewer to simultaneously broadcast with the broadcaster (e.g., alongside the broadcaster) on a live-stream video feed which can be viewed other viewers.

### SUMMARY OF EMBODIMENTS OF THE INVENTION

Embodiments of the invention include systems and methods for providing guest broadcasting on a live stream video platform. Embodiments may be performed on a server, for example, having a processor, memory, and one or more code sets stored in the memory and executing in the processor. In some embodiments, the method may include receiving a first request from a first client device to broadcast first media content to a plurality of viewing devices; receiving the first media content from the first client device and broadcasting the first media content to the plurality of viewing devices; receiving a second request to broadcast second media content to the plurality of viewing devices concurrently with the first media content, the second media content being received from a second client device; receiving the second media content from the second client device; blending or combining the first media content with the second media content; and broadcasting the first media content and the second media content concurrently as blended or combined media content to the plurality of viewing devices.

In some embodiments, the first media content may include first audio and first video being captured on the first client device, and the second media content comprises second audio and second video being captured on the second client device. In some embodiments, the method may further include negotiating between the server and the first client device, one or more parameters for broadcasting, in which the one or more parameters includes at least one of: a channel on which to broadcast, authorization to broadcast, and one or more transport protocols.

In some embodiments, the first media content and the second media content are each received in a peer-to-peer format and are each converted to a broadcasting format. In some embodiments, the peer-to-peer format may be Web Real Time Communication (WebRTC) format and wherein the broadcasting format may be Real Time Streaming Protocol (RTSP) format. In some embodiments, the second request may be received from at least one of the first client device and the second client device.

In some embodiments, combining may include decoding each of the first audio, the first video, the second audio, and the second video; mixing the first audio with the second audio and the first video with the second video; processing the mixed audio and the mixed video; encoding the mixed audio and the mixed video; and packaging the mixed audio and mixed video for simultaneous or near-simultaneous broadcast.

In some embodiments, broadcasting the first media content and the second media content concurrently as combined media content to the plurality of viewing devices may include providing the first video and the second video in a side-by-side view, and enabling the first audio and the second audio to be heard contemporaneously. In some embodiments, the method may further include enabling at least one of the first client device and the second client device to disable broadcasting the first media content and the second media content concurrently as combined media content to the plurality of viewing devices.

In further embodiments, systems and methods for providing guest broadcasting on a live stream video platform may include receiving a first request from a first client device to broadcast first media content to a plurality of viewing devices, the first media content being received from the first client device; receiving a second request to broadcast second media content to the plurality of viewing devices concurrently with the first media content, the second media content being received from a second client device; negotiating between the server, the first client device, and the second client device, one or more parameters for broadcasting; receiving the first media content from the first client device based on the negotiated parameters; receiving the second media content from the second client device based on the negotiated parameters; blending or combining the first media content with the second media content; and broadcasting the first media content and the second media content concurrently as blended or combined media content to the plurality of viewing devices based on the one or more negotiated parameters.

These and other aspects, features and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high level diagram illustrating an example configuration of a system for providing guest broadcasting on a live stream video platform according to at least one embodiment of the invention;

FIG. 2 is schematic of the YouNow “Guest Broadcasting” System according to at least one embodiment of the invention; and

FIG. 3 is an example view of interactions from the broadcaster perspective according to at least one embodiment of the invention.

FIG. 4 is an example view of a side-by-side interaction between the broadcaster and guest according to at least one embodiment of the invention.

FIG. 5 is an example view of the broadcaster control according to at least one embodiment of the invention.

FIG. 6 is an example view of interactions from the viewer/guest perspective according to at least one embodiment of the invention.

FIG. 7 is a high level flow diagram illustrating an example method for providing guest broadcasting on a live stream video platform according to at least one embodiment of the invention; and

FIG. 8 is a high level flow diagram illustrating an example blending process according to at least one embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the detailed description herein, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the invention provide a “guest broadcasting” and “talk show” feature on a live streaming video platform which allows any user to run an online video talk show from any internet-connected and camera-enabled mobile device or desktop computer anywhere in the world. Embodiment of the invention further enable selected guests to be invited by the broadcaster to participate via video from anywhere in the world, and on any internet-connected and camera-enabled device, while a global audience views and participates via chat messaging from any internet-enabled device.

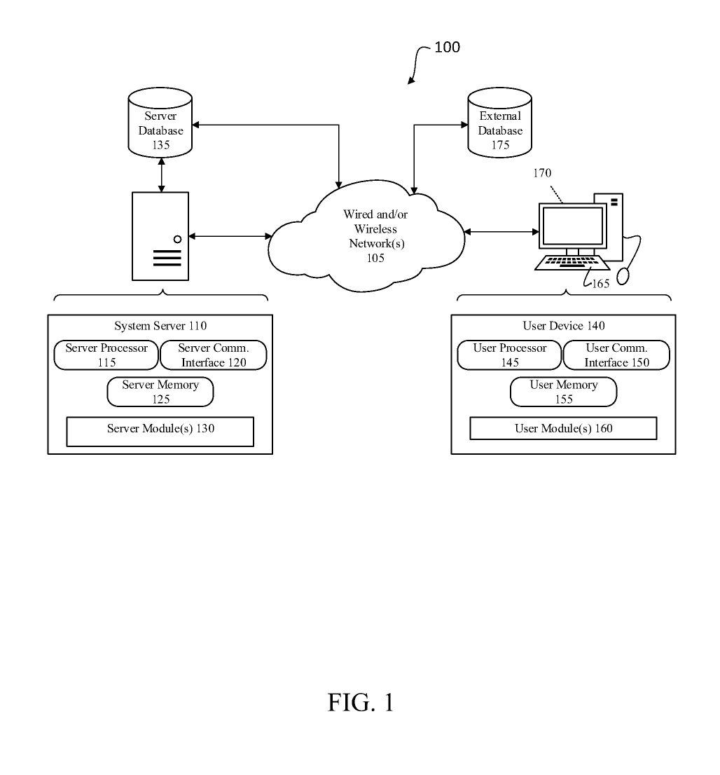

FIG. 1 shows a high level diagram illustrating an example configuration of a system 100 for performing one or more aspects of the invention described herein, according to at least one embodiment of the invention. System 100 includes network 105, which may include the Internet, one or more telephony networks, one or more network segments including local area networks (LAN) and wide area networks (WAN), one or more wireless networks, or a combination thereof. System 100 also includes a system server 110 constructed in accordance with one or more embodiments of the invention. In some embodiments, system server 110 may be a stand-alone computer system. In other embodiments, system server 110 may include a network of operatively connected computing devices, which communicate over network 105. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 105.

System server 110 may be any suitable computing device and/or data processing apparatus capable of communicating with computing devices, other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, mainframes, and other appropriate computers and/or networked or cloud based computing systems capable of employing the systems and methods described herein.

System server 110 may include a server processor 115 which is operatively connected to various hardware and software components that serve to enable operation of the system 100. Server processor 115 serves to execute instructions to perform various operations relating to advanced search, and other functions of embodiments of the invention as described in greater detail herein. Server processor 115 may be one or a number of processors, a central processing unit (CPU), a graphics processing unit (GPU), a multi-processor core, or any other type of processor, depending on the particular implementation.

System server 110 may be configured to communicate via communication interface 120 with various other devices connected to network 105. For example, communication interface 120 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 110 to other computing devices and/or communication networks such as private networks and the Internet.

In certain implementations, a server memory 125 is accessible by server processor 115, thereby enabling server processor 115 to receive and execute instructions such a code, stored in the memory and/or storage in the form of one or more software modules 130, each module representing one or more code sets. The software modules 130 may include one or more software programs or applications (collectively referred to as the “server application”) having computer program code or a set of instructions executed partially or entirely in server processor 115 for carrying out operations for aspects of the systems and methods disclosed herein, and may be written in any combination of one or more programming languages. Server processor 115 may be configured to carry out embodiments of the present invention by, for example, executing code or software, and may execute the functionality of the modules as described herein.

In some embodiments, the exemplary software modules may include a communication module, and other modules as described here. The communication module may be executed by server processor 115 to facilitate communication between system server 110 and the various software and hardware components of system 100, such as, for example, server database 135, client device 140, and/or external database 175 as described herein.

Of course, in some embodiments, server modules 130 may include more or less actual modules which may be executed to enable these and other functionalities of the invention. The modules described herein are therefore intended to be representative of the various functionalities of system server 110 in accordance with some embodiments of the invention. It should be noted that in accordance with various embodiments of the invention, server modules 130 may be executed entirely on system server 110 as a stand-alone software package, partly on system server 110 and partly on user device 140, or entirely on user device 140.

Server memory 125 may be, for example, a random access memory (RAM) or any other suitable volatile or non-volatile computer readable storage medium. Server memory 125 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 135, for example, directly or remotely via network 105. Database 135 may include any of the memory configurations as described herein, and may be in direct or indirect communication with system server 110. In some embodiments, database 135 may store information relating to user documents. In some embodiments, database 135 may store information related to one or more aspects of the invention.

As described herein, among the computing devices on or connected to the network 105 may be one or more user devices 140. User device 10 may be any standard computing device. As understood herein, in accordance with one or more embodiments, a computing device may be a stationary computing device, such as a desktop computer, kiosk and/or other machine, each of which generally has one or more processors, such as user processor 145, configured to execute code to implement a variety of functions, a computer-readable memory, such as user memory 155, a user communication interface 150, for connecting to the network 105, one or more user modules, such as user module 160, one or more input devices, such as input devices 165, and one or more output devices, such as output devices 170. Typical input devices, such as, for example, input devices 165, may include a keyboard, pointing device (e.g., mouse or digitized stylus), a web-camera, and/or a touch-sensitive display, etc. Typical output devices, such as, for example output device 170 may include one or more of a monitor, display, speaker, printer, etc.

In some embodiments, user module 160 may be executed by user processor 145 to provide the various functionalities of user device 140. In particular, in some embodiments, user module 160 may provide a user interface with which a user of user device 140 may interact, to, among other things, communicate with system server 110.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, user device 140 may be a “dummy” terminal, by which processing and computing may be performed on system server 110, and information may then be provided to user device 140 via server communication interface 120 for display and/or basic data manipulation. In some embodiments, modules depicted as existing on and/or executing on one device may additionally or alternatively exist on and/or execute on another device. For example, in some embodiments, one or more modules of server module 130, which is depicted in FIG. 1 as existing and executing on system server 110, may additionally or alternatively exist and/or execute on user device 140. Likewise, in some embodiments, one or more modules of user module 160, which is depicted in FIG. 1 as existing and executing on user device 140, may additionally or alternatively exist and/or execute on system server 110.

Embodiments of the invention provide a guest broadcasting feature which allows broadcasting users, e.g., star broadcasters, to invite their viewers to join their discussions in a real-time fashion through the guest's own video feed, from anywhere in the world. This makes for a real-time, interactive, video discussion, essentially giving any user the ability to run a video talk-show from anywhere in the world.

Guest broadcasting allows a broadcaster to select viewers directly from their online viewing audience, and enable them to be streamed live, e.g., side-by-side with or in place of the broadcaster. To request to become a guest broadcaster, in some embodiments viewers may be required to opt-in, e.g., by creating a GIF animation preview or other image (e.g., a .PNG or .JPEG, etc.), which gives the broadcaster a visual indication of how their guest will appear on camera. Alternatively, guests may be invited to go live directly by the broadcaster. Once a guest is live with the broadcaster, they can seamlessly interact in real-time. In some embodiments, either person can end the guest's stream whenever desired. In some embodiments, the viewing audience may see both broadcaster and guest, e.g., in a split screen on their devices, and can participate via chat messaging which is visible to all participants.

There are multiple video programs and applications (apps) on the market that enable video based interaction, and they can be categorized into the four categories listed below. However, guest broadcasting according to embodiments of the invention is unique and inherently different from each of them in that it is a fully-fledged social and public experience (of course, other differences exist between the systems and methods described herein and other systems and methods, beyond those described herein.):

Live broadcasting networks with no audience video participation, such as Periscope, Upclose, Facebook® Live: These networks do not allow for guest broadcasting, but only one-to-many video, where the audience can chat but not become part of the broadcast as a guest.

Live broadcasting network with audience video participation, but no joint broadcasting, such as Meerkat: using Cameo (a Meerkat feature), a broadcaster on Meerkat can integrate a guest stream in, but not broadcast together with them or interact with them—so at any given point only one stream is playing. This is fundamentally different, technologically and functionally, from YouNow's Guest Broadcasting, which is intended to allow for interaction between broadcasters and for more than one stream to play, simultaneously.

Group video chat services or apps, such as Google® Hangouts, Skype®, ooVoo®, Rounds: These apps allow multiple users to participate in a private video chat among friends/colleagues. On these apps there is no public aspect to the video chat, so that unlike YouNow's Guest Broadcasting, they are: (A) Not publicly broadcasted and closed for any other user to watch (B) Limited to people one knows in advance—not connecting broadcaster with new people. On YouNow, there is a clear broadcast host who brings guests into/takes guests off the public broadcast as he/she sees fit. These guests can be anyone from an audience of thousands watching the broadcast, users that the broadcaster may have never had contact with before, who simply tuned in to the broadcast. Meeting new people this way is a fundamental attribute of the product. (3) Do not allow for audience participation, as they do not allow anyone who is not on the video conference to participate freely in the broadcast chat, and potentially be called into a broadcast. The YouNow broadcast is an experience usually shared by hundreds or thousands of people who act as active participants, rather than a closed-conversation room.

Joint livestreaming services, such as Blab: Unlike YouNow, Blab is (1) Available on web only, while more than 80% of usage on YouNow is on the mobile app, and guest broadcasting is enabled across devices (web iOS, Android). (2) Has no gamification or networking elements that come into play when creating the joint broadcast. YouNow's Guest Broadcasting is woven into the highly gamified environment that includes user levels, badges, statuses (e.g. top fan), virtual gifts, subscriptions etc. These are integral part of Guest Broadcasting on YouNow that are used to determine the order and appearance of users on the Guest Broadcasting queue—the audience list from which the broadcaster pulls in guests. On Blab a broadcaster leaves “a spot” for up to 4 users to call in, with virtually no information other than their handle (usernames). However, on YouNow, the broadcaster pulls in people as part of the “game”—the hosts decide who can be in their show, and their potential guests queue up and are ranked by level of engagement with the host and YouNow as a whole. With the ability to upload GIFs while in queue, potential guests give hosts a taste of their personality so that they can better curate the direction of their show. Dozens or hundreds of users can opt in to guest broadcasting on a given broadcast. No other public joint livestreaming service offers such a level of personalization and audience engagement in joint broadcasting.

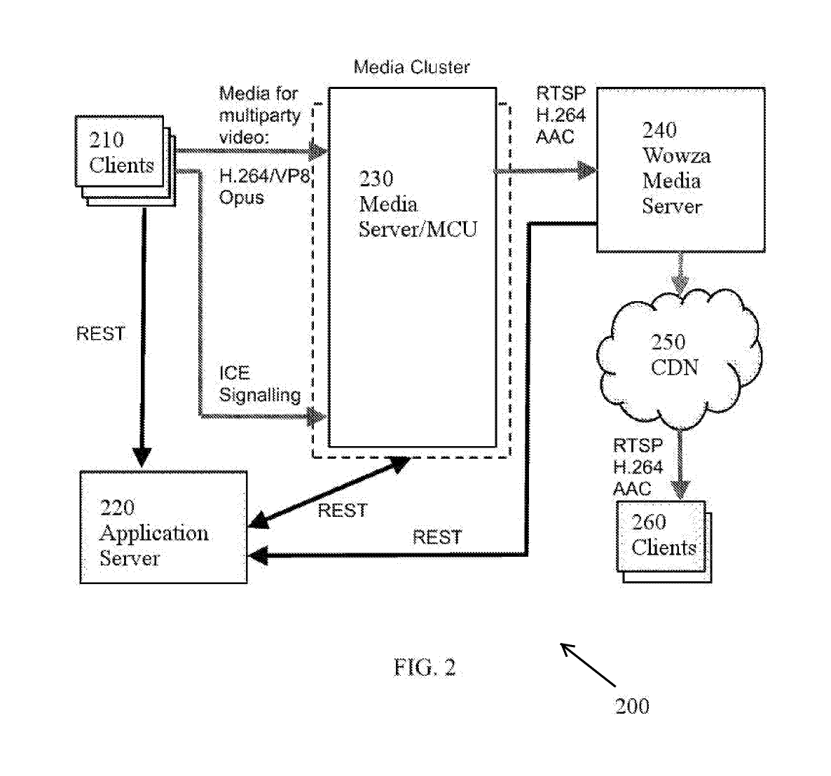

Turning to FIG. 2, a schematic of the YouNow “Guest Broadcasting” System 200 is shown according to some embodiments of the invention. In some embodiments, YouNow “Guest Broadcasting” System 200 may include one or more of each of the following components: Broadcasting clients 210, application server 220, media cluster 230, media server 240, content delivery network (CDN) 250, and viewing clients 260.

In some embodiments, each broadcasting client 210 (e.g., a software client installed or resident on a device of a broadcasting user; also referred to as a client device) may include a video streaming library, e.g., developed by YouNow, which may be based on, e.g., Google's Web Real Time Communication (WebRTC) Software Development Kit (SDK), a kit allowing developers to integrate 3rd party software, but may include changes to support hardware acceleration for various video compression formats such as, e.g., VP8 and H.264. In some embodiments, the library may be responsible for the managing a client-side WebRTC call setup flow. First, the library may create a Session Description Protocol (SDP) offer packet which may be sent to the Media Cluster 230 (described herein), e.g., over RESTful APIs. Representational State Transfer (REST) is a software architectural style which includes a coordinated set of architectural constraints applied to components, connectors, and data elements, within a distributed hypermedia system. REST ignores the details of component implementation and protocol syntax in order to focus on the roles of components, the constraints upon their interaction with other components, and their interpretation of significant data elements.

Typically, an Application Programming Interface (API) is understood as a particular set of rules and specifications that a software program can follow to access and make use of the services and resources provided by another particular software program that implements that API. The API serves as an interface between different software programs and facilitates their interaction, similar to the way the user interface facilitates interaction between humans and computers.

The Media Cluster 230 and the broadcasting client 210 may then initiate a negotiation, e.g., an Interactive Connectivity Establishment (ICE) candidate negotiation. ICE is a protocol for negotiating peer-to-peer (p2p) communications. The negotiation may enable broadcasting client 210 and Media Cluster 230 to decide on how to transport the media in an efficient, secured manner. Finally, broadcasting client 210 may stream the media directly to the Media Cluster 230, e.g., in H.264/VP8 or OPUS format.

In some embodiments, broadcasting clients 210 may include all the product components, and API integrations with YouNow's Applications Server 220 (described herein) to facilitate a clear and fluid user experience for users who may wish to broadcast to viewers on YouNow, and invite other YouNow users to Guest Broadcast with them, using, e.g., YouNow's iOS and/or Android applications or website. Those components may include, but are not limited to, user interface (UI) views, buttons, dialogs, animations, etc., all specifically tailored to expertly compose a concise and user-friendly experience.

In some embodiments, Application Server 220 may be driving the business logic and methods which enable guest broadcasting as described herein. The application server may handle one or more of the following functionalities:

Processing requests from the client to broadcast. The request handling may be done on multiple levels to enable an easy, efficient and secure way of communication between users on YouNow. This may include, e.g., the following layers: Application Layer—e.g., identifies which channel the broadcaster would like to use, whether the broadcaster would like to invite a specific guest, and/or which guests have opted-in to broadcast with the broadcaster. Security Layer—i.e., determines whether the broadcaster is allowed to broadcast, whether the broadcaster approves a guest to broadcast with her, etc. Call Setup Layer—bridges the communication between the broadcasting client 210 and the Media Cluster 230, helping in the transport of SDP offers/answers between them.

In some embodiments, Application Server 220 may allow guest broadcasters to join in and/or drop out of a broadcast while the Media Cluster 230 handles all the back and forth between broadcasters and guests. In some embodiments, guests may use RESTful API requests to opt-in to and/or opt-out of broadcasting with a broadcaster. The broadcaster in turn decides whether to accept/reject a request and/or invite a guest to broadcast with them.

In some embodiments, Application Server 220 may process stream quality reports from the Media Cluster 230. In some embodiments, Media Cluster 230 may periodically send quality reports back to the Application Server 220, notifying it, e.g., on quality parameters of clients' published streams, for example, frames per second, key frame rate, bitrate per second, resolution, etc. Upon receiving the aforementioned quality reports, the application server 220 may determine whether to allow a broadcast to keep on running, or whether to initiate a forced disconnect. In some embodiments, Application Server 220 may mitigate all streaming failures and edge cases gracefully.

In some embodiments, Media Cluster 230 may be responsible for at least two main functionalities: Protocol bridging, and media blending and processing, as described herein.

WebRTC is a peer-to-peer based technology. What this essentially means is that content delivery between endpoints is not passed using dedicated networks with guaranteed bandwidth and quality-of-service. Content providers usually depend on Content Delivery Networks (CDNs, described herein) to guarantee efficient and reliable delivery of content to endpoints everywhere. CDNs are based on a network of data centers in various geographic locations, with dedicated traffic pipelines connecting them. CDNs ensure the availability of all content throughout their network's distribution, allowing clients to consume media with minimal delay and interruptions. Instead, WebRTC relies on the endpoints themselves to deliver the content amongst themselves, with no use of dedicated bandwidth, and only with the bandwidth they have available.

WebRTC was built to allow a one-to-one model of communication, with the idea of competing with platforms like Skype, using open-source technology, and license-free CODECs (Coder-Decoder—software used to code Audio and Video). WebRTC could be extended to support a party chat use, but at a cost—with each additional member which joins the party, there is a higher resources requirement from each member (Network bandwidth, CPU load). This is due to the fact that each member needs to send her media to each one of the members in the party. The extra resource load could result in unfavorable impact such as increased latency (e.g., the amount of time passed from the moment a certain video frame left the Sender, until it arrived to the recipient, and video stuttering (e.g., non-smooth video experience due to high CPU load, or limited network bandwidth).

As such, WebRTC is not the ideal solution for the kind of service supported by embodiments of the invention. A platform (such as YouNow) according to embodiments of the invention may offer a one-to-many (One Sender to Many Recipients—also referred to as broadcast) service, in which the “many” amounts to tens of thousands of concurrent recipients, for example. WebRTC is currently not mature enough technologically to offer a commercial-level solution for such a business need.

Therefore, in some embodiments, Media Cluster 230 may resolve this challenge by converting a video which has been generated in a one-to-one (peer-to-peer) format, e.g., WebRTC format at a WebRTC endpoint, into a broadcast-suitable format—e.g., RTSP. RTSP was built to facilitate real time streaming to many recipients. The technology has been heavily used commercially, and has been battle tested. In some embodiments, the Media Cluster 230 may receive the media (video and/or audio) from the broadcasting client 210, and without changing anything in the video itself (e.g., the actual video frames which are sent in Real Time Transport Protocol—RTP—remain unchanged), Media Cluster 230 may change the way the media content is “packaged,” e.g., from WebRTC to RTSP, and send the media content to the Media Server 240, (described herein) e.g., a Wowza media server, which in turn allows the video to be consumed by its many recipients.

In some embodiments, the Media Cluster 230 may further handle Media blending and processing. As previously discussed, it is practically impossible to deliver a video stream to tens of thousands of recipients at the same time using WebRTC or other peer-to-peer formats. Accordingly, it is even more complicated to pass two synchronized video streams simultaneously to the same crowd, while assuring a good viewing experience to the recipients. The synchronization of the two streams is a key factor in to the viewing experience. Any latency between the two streams would result in an unfavorable experience to the viewer. For example, a phone call in which it takes two seconds for each word to be transmitted to the other would be unacceptable as it would be impossible to have any proper discussion. The same is true for synchronized video streams.

In some embodiments, the Media Cluster 230 may solve this issue by blending or combining two peer-to-peer (e.g., WebRTC) incoming streams together. WebRTC, for example, assures that each video stream would arrive at the Media Cluster 230 with very low latency, and as a result the two may be synchronized. The Media Cluster in turn blends or otherwise combines the two streams (or portions thereof) into one blended or combined stream (e.g., in a 50:50 or other ratio, side-by-side, above-below, picture-on-picture, overlaid layout, etc., or any combination thereof). The blended stream (e.g., a composite of all or parts of the two original streams) may then be packaged in RTSP, and streamed to the Media Server 240. The blended stream guarantees a uniform viewing experience between all the recipients. This may have a similar effect to that of recorded phone call, which will always sound the same, no matter to how many people it is played for at the same time. A blended video stream is essentially analogous to a recorded phone call played in a big room with tens of thousands of people, with no asynchronicity.

In some embodiments, Media Server 240 may receive the blended stream (e.g., blended media content of the broadcaster and the guest) from the Media Cluster 230, using RTSP protocol. Media Server 240 may then ready the video stream to be consumed by the Content Delivery Network 250. In some embodiments, Media Server 240 may be may be an industry leading Media Server, such as the Wowza Media server product. In some embodiments, the Media Server 240 may also be configured to archive the blended media content (e.g., the video and audio stream composed of concurrent feeds from the broadcaster and the guest) for later use, and/or for sending periodic quality reports regarding each stream to the Application Server 240.

As described herein, content delivery networks (CDNs) are used by content providers to ensure an efficient and reliable content delivery to users across the world. In some embodiments, CDN 250 may extract video streams from one or many Media Servers 240, and make them available in various data centers, e.g., located in strategic geographic locations, for users to consume.

In some embodiments, viewing clients 260 may access using a website (e.g., YouNow's website) or a native application (e.g., iOS and/or Android apps) resident on a client device to connect to CDN 250 endpoints, and stream the available video content being hosted.

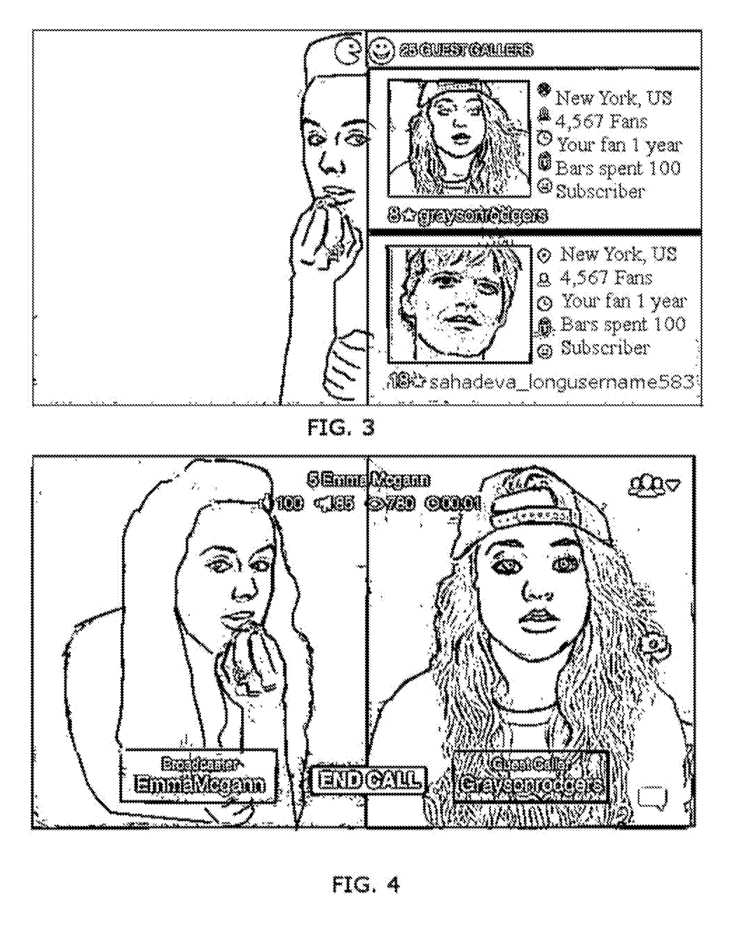

Turning to FIG. 3, an example of interactions from the broadcaster perspective is shown according to embodiments of the invention. Embodiments of the invention may provide a website and/or mobile native applications which may include a user-friendly, custom made user interface encouraging users to invite their viewers to “Guest Broadcast” with them. Each broadcaster may be presented with an audience list, sorted based on relevance, e.g., pointing out the most attractive users in the list according to calculated social-graph information. Each viewer on the list may have actively opted-in to participate in the Guest Broadcast. Opted-in users may wait for the broadcaster to choose the next viewer to Guest Broadcast with her.

In some embodiments, before opting in into the guest waiting-list, viewers may be encouraged to create a short animated video (e.g., a GIF) of themselves, e.g., using YouNow's app, showing their talents, and making themselves exciting, and interesting to the broadcaster. In some embodiments, the animated GIF may be visible to both broadcaster and other viewers following the broadcaster, or only to the broadcaster. In some embodiments, the broadcaster may have the option of going through the list and choosing the viewers she deems the most appropriate viewers to join her in her broadcast. In some embodiments, the animated GIFs may also be used as a safety precaution allowing the broadcaster to filter inappropriate candidates.

As shown in FIG. 4 according to embodiments of the invention, once the broadcaster decides on whom to invite, the windows or displays showing the broadcaster and the guest may be positioned side-by-side, above-below, etc., e.g., in a 50:50 layout, and direct communication may be enabled between the two participants. In some embodiments, clients 210 may using modern echo-cancellation technologies to prevent audio leaks from the speaker to the microphone, and vice-versa. Hence, the participants do not need to make use of headphones while they broadcast, and are free to move freely without any limitation.

As shown in FIG. 5 according to embodiments of the invention, the broadcaster may have the ultimate control over the blended live broadcast show—and the broadcaster may choose to remove the guest from the broadcast at any time. In some embodiments, the guest may also choose to leave the broadcast on her own accord, but may be unable to end the Guest Broadcast as a whole; only the broadcaster may have the power to do so.

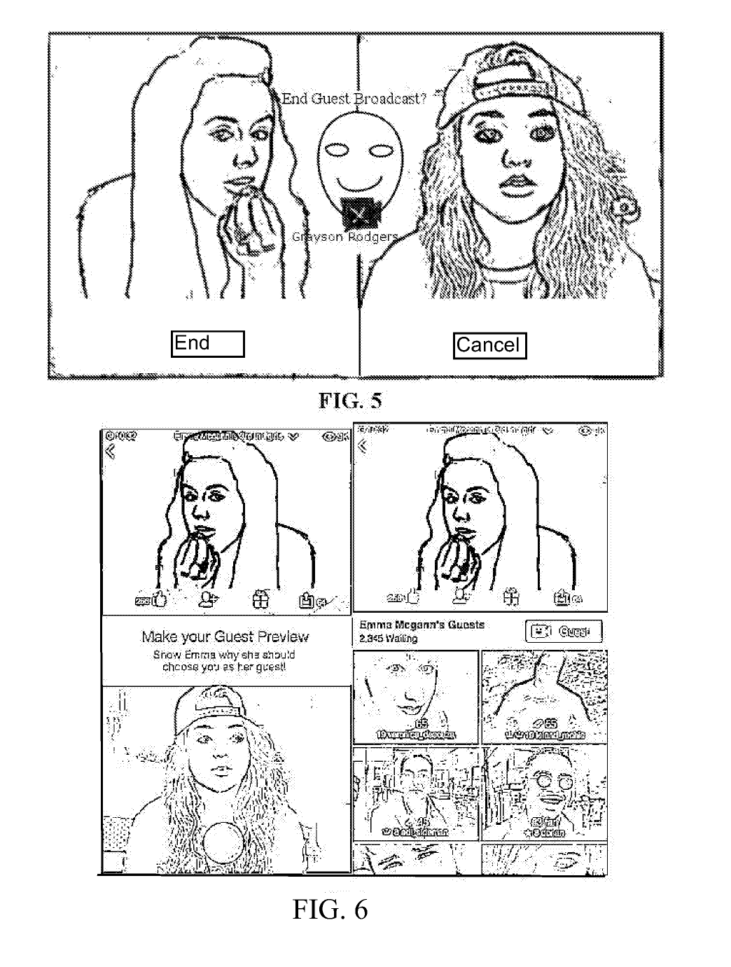

FIG. 6 shows an example of interactions from a VIEWER/GUEST perspective according to embodiments of the invention. First and foremost, viewers are witnesses to a live conversation between two internet personalities, possibly together with tens of thousands of other people watching it at the same time. In some embodiments, the viewers may further be provided the opportunity to influence the ongoing conversation, to make observations on the latest happening and to share their ideas with the other viewers.

In some embodiments, viewers could opt-in to become guests at any given point, and to promote their status in the guest waiting line, by interacting with the broadcaster. Viewers are encouraged to create additional high-value GIF animations of themselves, and share those with the broadcaster, as well as with the rest of the viewers. The GIFs allow the viewers to make themselves more attractive to the broadcaster, and potentially also catch the attention of the viewers. Viewers could actually try and drive the broadcaster's attention to the fact that one of the opted-in guests is highly exciting to them, and as a result become content curators. In this model, all the participants—Broadcaster, Guests, Viewers are contributing their own share to create a content ecological system which shifts the power and attention between all its members.

In some embodiments, viewers (e.g., viewing clients 260 anywhere in the world) may be able to make themselves available and/or to opt-in to be selected as guests through a unique pre-roll recording service allowing the broadcaster to see short GIF animations of possible guests to her show. Embodiments of the invention may allow for the broadcaster to select guests from a sorted list of opted-in viewers and for the broadcaster to manage the participation of such guests.

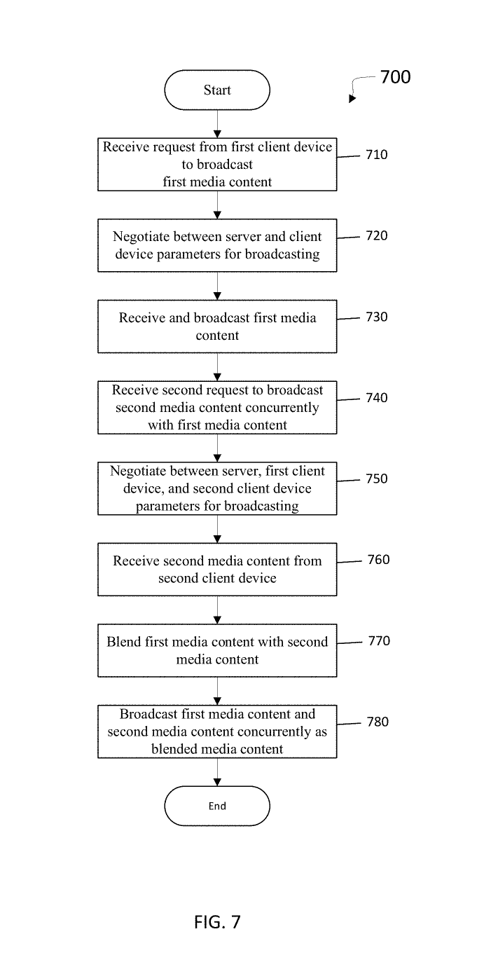

As shown in FIG. 7, a flow diagram of a method 700 for providing for providing guest broadcasting on a live stream video platform is shown according to embodiments of the invention. In some embodiments, method 700 may be performed on a computer or server (e.g., system server 110) having a processor (e.g., server processor 115), memory (e.g., server memory 125), and one or more code sets (e.g., server module(s) 130) stored in the memory and executing in the processor. The method begins at step 710, when the processor receives a first request from a first client device (e.g., broadcaster client 210) to broadcast first media content (e.g., first audio and/or first video being captured on the first client device) to a plurality of viewing devices (e.g., one or many viewing clients 260). At step 720, the processor may negotiate between the server and the first client device one or more parameters for broadcasting. In some embodiments, the one or more parameters may include, for example, at least one of: a channel on which to broadcast, authorization to broadcast, and one or more transport protocols, as described herein.

At step 730, the processor may receive the first media content from the first client device and broadcast the first media content to the plurality of viewing devices based on the negotiated parameters. For example, as described herein, in some embodiments, the first media content may be received in a peer-to-peer format (e.g., Web Real Time Communication (WebRTC) format) and converted to a broadcasting format (Real Time Streaming Protocol (RTSP) format) for broadcasting to the viewers.

At step 740, the processor may receive a second request to broadcast second media content received from a second client device (e.g., second audio and/or second video being captured on the second client device) to the plurality of viewing devices concurrently with the first media content. In various embodiments, the second request may be received from the first client device, the second client device, or both client devices.

At step 750, the processor may negotiate between the server, the first client device, and the second client device, one or more revised parameters for broadcasting. For example, one or more revised parameters may include at least one of: a channel on which to broadcast, authorization to broadcast, and one or more transport protocols, as described herein.

At step 760, the processor may receive the second media content from the second client device. As with the first media content, the second media content may include second audio and/or second video, e.g., being captured on the second client device. Likewise, in some embodiments, the second media content may be received in a peer-to-peer format (e.g., Web Real Time Communication (WebRTC) format) and converted to a broadcasting format (Real Time Streaming Protocol (RTSP) format) for broadcasting to the viewers.

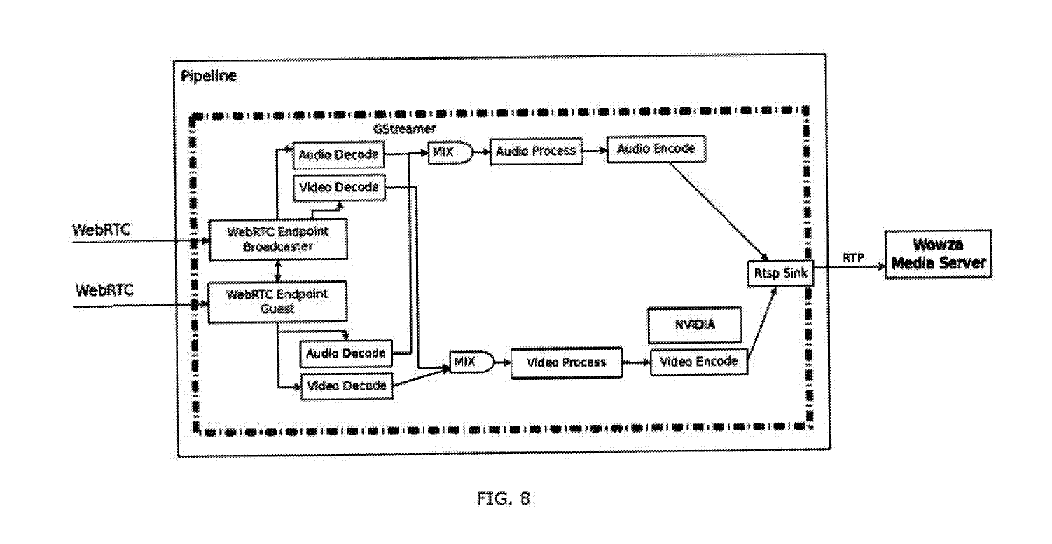

At step 770, the processor may blend the first media content with the second media content. Turning briefly to FIG. 8, a flow diagram of the blending process is shown, in which the following steps are taken to blend the first media content and the second media content once they are receive at steps 810A and 810B: at step 820A and 830A, respectively, the processor may decode each of the first video, the first audio, at step 820B and 830B, respectively, the processor may decode each of the second video, and the second audio. At step 840A the processor may mix the first audio with the second audio, and at step 840B the processor may mix the first video with the second video. Once the audio and video are properly mixed, at steps 850A and 850B respectively, the processor may process the audio and video. Next, at steps 860A and 860B respectively, the processor may encode the mixed audio and the mixed video; and at step 870 the processor may package the mixed audio and mixed video for simultaneous or near-simultaneous broadcast via a media server (e.g., Media Server 240).

Returning to FIG. 7, at step 780 the processor may broadcast the first media content and the second media content concurrently as blended media content to the plurality of viewing devices based on the one or more revised parameters. As described herein, the blended media content may have been initially received as two Web Real Time Communication (WebRTC) formatted media, yet they may be broadcasted in Real Time Streaming Protocol (RTSP) format. Furthermore, in some embodiments, the blended media content may be provided in a side-by-side view, enabling the first video content and second video content to be viewed concurrently, and enabling the first audio and the second audio to be heard contemporaneously.

As described herein, embodiments of the invention may be implemented by the media cluster 230 to transcode and convert a video stream created at a standard WebRTC endpoint into a broadcast suitable format. Additionally specialized methods described herein synchronize streams to provide a seamless viewing experience for viewers.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method for providing guest broadcasting on a live stream video platform, performed on a server having a processor, memory, and one or more code sets stored in the memory and executing in the processor, the method comprising:
receiving, by the processor, a first request from a first client device to broadcast first media content to a plurality of viewing devices;
receiving, by the processor, the first media content from the first client device and broadcasting the first media content to the plurality of viewing devices;
receiving, by the processor, a second request to broadcast second media content to the plurality of viewing devices concurrently with the first media content, the second media content being received from a second client device;
receiving, by the processor, the second media content from the second client device;
combining, by the processor, the first media content with the second media content; and
broadcasting, by the processor, the first media content and the second media content concurrently as combined media content to the plurality of viewing devices.

2. The method as in claim 1, wherein, the first media content comprises first audio and first video being captured on the first client device, and the second media content comprises second audio and second video being captured on the second client device.

3. The method as in claim 1, further comprising: negotiating, by the processor, between the server and the first client device, one or more parameters for broadcasting, wherein the one or more parameters comprises at least one of: a channel on which to broadcast, authorization to broadcast, and one or more transport protocols.

4. The method as in claim 1, wherein the first media content and the second media content are each received in a peer-to-peer format and are each converted to a broadcasting format.

5. The method as in claim 4, wherein the peer-to-peer format is Web Real Time Communication (WebRTC) format and wherein the broadcasting format is Real Time Streaming Protocol (RTSP) format.

6. The method as in claim 1, wherein the second request is received from at least one of the first client device and the second client device.

7. The method as in claim 2, wherein combining further comprises:
decoding, by the processor, each of the first audio, the first video, the second audio, and the second video;
mixing, by the processor, the first audio with the second audio and the first video with the second video;
processing the mixed audio and the mixed video;
encoding the mixed audio and the mixed video; and
packaging the mixed audio and mixed video for simultaneous or near-simultaneous broadcast.

8. The method as in claim 2, wherein broadcasting, by the processor, the first media content and the second media content concurrently as combined media content to the plurality of viewing devices comprises providing the first video and the second video in a side-by-side view, and enabling the first audio and the second audio to be heard contemporaneously.

9. The method as in claim 1, further comprising enabling at least one of the first client device and the second client device to disable broadcasting the first media content and the second media content concurrently as combined media content to the plurality of viewing devices.

10. A method for providing guest broadcasting on a live stream video platform, performed on a server having a processor, memory, and one or more code sets stored in the memory and executing in the processor, the method comprising:
receiving, by the processor, a first request from a first client device to broadcast first media content to a plurality of viewing devices, the first media content being received from the first client device;
receiving, by the processor, a second request to broadcast second media content to the plurality of viewing devices concurrently with the first media content, the second media content being received from a second client device;
negotiating, by the processor, between the server, the first client device, and the second client device, one or more parameters for broadcasting;
receiving, by the processor, the first media content from the first client device based on the negotiated parameters;
receiving, by the processor, the second media content from the second client device based on the negotiated parameters;
blending, by the processor, the first media content with the second media content; and
broadcasting, by the processor, the first media content and the second media content concurrently as blended media content to the plurality of viewing devices based on the one or more negotiated parameters.

11. The method as in claim 10, wherein, the first media content comprises first audio and first video being captured on the first client device, and the second media content comprises second audio and second video being captured on the second client device.

12. A system for providing guest broadcasting on a live stream video platform, comprising:
a server having a processor and memory; and
one or more code sets stored in the memory and executing in the processor, which, when executed, configure the processor to:
receive a first request from a first client device to broadcast first media content to a plurality of viewing devices;
receive the first media content from the first client device and broadcast the first media content to the plurality of viewing devices;
receive a second request to broadcast second media content to the plurality of viewing devices concurrently with the first media content, the second media content being received from a second client device;
receive the second media content from the second client device;
combine the first media content with the second media content; and
broadcast the first media content and the second media content concurrently as combined media content to the plurality of viewing devices.

13. The system as in claim 12, wherein, the first media content comprises first audio and first video being captured on the first client device, and the second media content comprises second audio and second video being captured on the second client device.

14. The system as in claim 12, wherein the processor is further configured to: negotiate between the server and the first client device, one or more parameters for broadcasting, wherein the one or more parameters comprises at least one of: a channel on which to broadcast, authorization to broadcast, and one or more transport protocols.

15. The system as in claim 12, wherein the first media content and the second media content are each received in a peer-to-peer format and are each converted to a broadcasting format.

16. The system as in claim 15, wherein the peer-to-peer format is Web Real Time Communication (WebRTC) format and wherein the broadcasting format is Real Time Streaming Protocol (RTSP) format.

17. The system as in claim 12, wherein the second request is received from at least one of the first client device and the second client device.

18. The system as in claim 13, wherein, when combining, the processor is further configured to:
decode each of the first audio, the first video, the second audio, and the second video;
mix the first audio with the second audio and the first video with the second video;
process the mixed audio and the mixed video;
encode the mixed audio and the mixed video; and
package the mixed audio and mixed video for simultaneous or near-simultaneous broadcast.

19. The system as in claim 13, wherein, when broadcasting, the processor is further configured to provide the first video and the second video in a side-by-side view, and enable the first audio and the second audio to be heard contemporaneously.

20. The system as in claim 12, wherein the processor is further configured to enable at least one of the first client device and the second client device to disable broadcasting the first media content and the second media content concurrently as combined media content to the plurality of viewing devices.
